(19) United States
(12) Patent Application Publication
(10) Pub. No.: US 2014/0133174 A1
(43) Pub. Date: May 15, 2014

(54) Displays and Display Chassis Structures

(71) Applicant: APPLE INC., Cupertino, CA (US)

(72) Inventors: Jeremy C. Franklin, San Francisco, CA (US); Kevin D. Gibbs, San Carlos, CA (US); Amy Qian, San Jose, CA (US); John Raff, Menlo Park, CA (US); Michael J. Reilly, San Jose, CA (US); Altan N. Yazar, Los Altos, CA (US)

(73) Assignee: Apple Inc., Cupertino, CA (US)

(21) Appl. No.: 13/673,649

(22) Filed: Nov. 9, 2012

(51) Int. Cl. G09F 13/18; F21V 9/08

(52) U.S. Cl. CPC G09F 13/18; F21V 9/08
USPC 362/606; 362/611

(57) ABSTRACT

Electronic devices may include displays. A display may include backlight components that provide backlight illumination for the display. Backlight components may include a light guide plate that distributes light from a light source across the display. A plastic display chassis may be used to support display layers and backlight components. A light blocking material such as a layer of metal or opaque coating material may be formed on a surface of the plastic display chassis and may be used to reduce light leakage from the backlight components to the exterior of the electronic device. A metal barrier structure may be formed on a surface of the support structure and may be used to ground a conductive display layer to a conductive support structure such as a metal display chassis or a metal housing member. The plastic display chassis may be insert molded around a light barrier structure.

### BACKGROUND

This relates generally to electronic devices, and more particularly, to electronic devices with displays.

Electronic devices often include displays. For example, cellular telephones and portable computers often include displays for presenting information to a user. An electronic device may have a housing such as a housing formed from plastic or metal. Components for the electronic device such as display components may be mounted in the housing.

It can be challenging to incorporate a display into the housing of an electronic device. Size, weight, electrical grounding, robustness, ease of assembly, and light-tightness are often important considerations in designing electronic devices. If care is not taken, displays may be bulky, may exhibit undesired light reflections, or may be prone to damage during a drop event. The housing of an electronic device can be adjusted to accommodate a bulky display with large borders, but this can lead to undesirable enlargement of the size and weight of the housing and unappealing device aesthetics.

It would therefore be desirable to be able to provide improved displays for electronic devices.

### SUMMARY

An electronic device may be provided with a display. The display may have display layers for displaying images. Backlight structures such as a light source and a light guide plate may be included in the display. The backlight structures may provide backlight that illuminates the display layers in the display that display images for a user.

The display may include an electric field shielding layer such as an electrostatic discharge protection layer. The electrostatic discharge protection layer may include a blanket layer of indium tin oxide formed on a display layer such as a color filter layer. The electrostatic discharge protection layer may ensure that electric fields caused by electrostatic charges to not disrupt a liquid crystal layer in the display.

A display may include a plastic chassis structure that surrounds a light guide plate. The plastic chassis structure may have a protruding portion interposed between the electrostatic discharge protection layer and the light guide plate. An adhesive may be used to attach the light guide plate to the protruding portion of the plastic chassis structure.

The plastic chassis structure may have an interior surface adjacent to the light guide plate. A conductive material such as a metal barrier structure may be formed on the interior surface of the plastic chassis structure. The metal barrier structure may be used to electrically connect the electrostatic discharge protection layer to a conductive support structure such as a metal display chassis or a metal housing member.

The metal barrier structure may also be used to increase backlight efficiency and to reduce light leakage from backlight structures by reflecting light towards the light guide plate. The metal barrier structure may be electroplated onto the surface of the plastic chassis structure or may be a metal structure around which the plastic chassis structure is insert molded.

A light barrier structure may be formed within the plastic chassis structure. The light barrier structure may be formed from metal or may be formed from an opaque plastic. The light barrier structure may be configured to reflect light through the plastic chassis structure towards the light guide plate.

A reflective film may be interposed between the plastic chassis structure and the light guide plate. The reflective film may be formed on an interior surface of the plastic chassis structure and may be configured to reflect light towards the light guide plate.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with a display in accordance with an embodiment of the present invention.

FIG. 2 is a perspective view of an illustrative electronic device such as a handheld electronic device with a display in accordance with an embodiment of the present invention.

FIG. 3 is a perspective view of an illustrative electronic device such as a tablet computer with a display in accordance with an embodiment of the present invention.

FIG. 4 is a schematic diagram of an illustrative electronic device with a display in accordance with an embodiment of the present invention.

FIG. 5 is a cross-sectional side view of an illustrative display in accordance with an embodiment of the present invention.

FIG. 6 is a cross-sectional side view of illustrative display layers and backlight structures in accordance with an embodiment of the present invention.

FIG. 7 is a perspective view of a light guide plate and corresponding chassis structure in accordance with an embodiment of the present invention.

FIG. 8 is a cross-sectional side view of illustrative display layers, backlight structures, and a chassis structure in accordance with an embodiment of the present invention.

FIG. 9 is a cross-sectional side view of an illustrative chassis structure that has been coated with a light blocking material in accordance with an embodiment of the present invention.

FIG. 10 is a perspective view of a chassis structure of the type shown in FIG. 9 showing how the chassis structure may be selectively coated with a light blocking material in accordance with an embodiment of the present invention.

FIG. 11 is a cross-sectional side view of an illustrative chassis structure that has been coated with a light blocking material in accordance with an embodiment of the present invention.

FIG. 12 is a cross-sectional side view of an illustrative chassis structure that has a light barrier structure formed within the chassis structure in accordance with an embodiment of the present invention.

FIG. 13 is a cross-sectional side view of an illustrative chassis structure that has a light barrier structure formed on an exterior surface of the chassis structure in accordance with an embodiment of the present invention.

FIG. 14 is a cross-sectional side view of an illustrative chassis structure that has a light barrier structure formed on an interior surface of the chassis structure in accordance with an embodiment of the present invention.

FIG. 15 is a cross-sectional side view of an illustrative display in which a metal barrier structure is formed on the surface of a chassis structure and is electrically connected to an electrostatic discharge protection layer in accordance with an embodiment of the present invention.

FIG. 16 is a flow chart of illustrative steps involved in forming a chassis structure of the type shown in FIG. 9 in accordance with an embodiment of the present invention.

FIG. 17 is a flow chart of illustrative steps involved in forming a chassis structure of the type shown in FIG. 11 in accordance with an embodiment of the present invention.

FIG. 18 is a diagram showing how in-mold decorating techniques may be used to form a light barrier structure on the surface of a chassis structure in accordance with an embodiment of the present invention.

### DETAILED DESCRIPTION

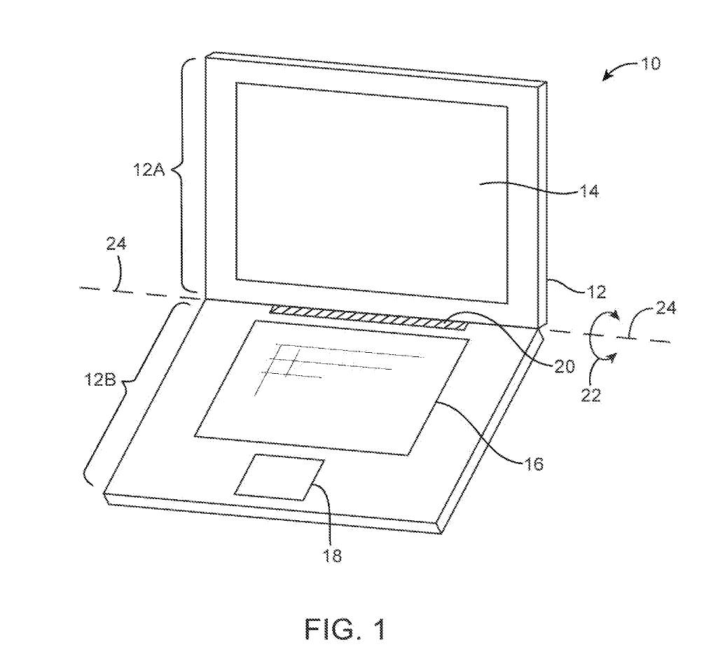

Electronic devices may include displays. The displays may be used to display images to a user. Illustrative electronic devices that may be provided with displays are shown in FIGS. 1, 2, and 3.

FIG. 1 shows how electronic device 10 may have the shape of a laptop computer having upper housing 12A and lower housing 12B with components such as keyboard 16 and touchpad 18. Device 10 may have hinge structures 20 that allow upper housing 12A to rotate in directions 22 about rotational axis 24 relative to lower housing 12B. Display 14 may be mounted in upper housing 12A. Upper housing 12A, which may sometimes referred to as a display housing or lid, may be placed in a closed position by rotating upper housing 12A towards lower housing 12B about rotational axis 24.

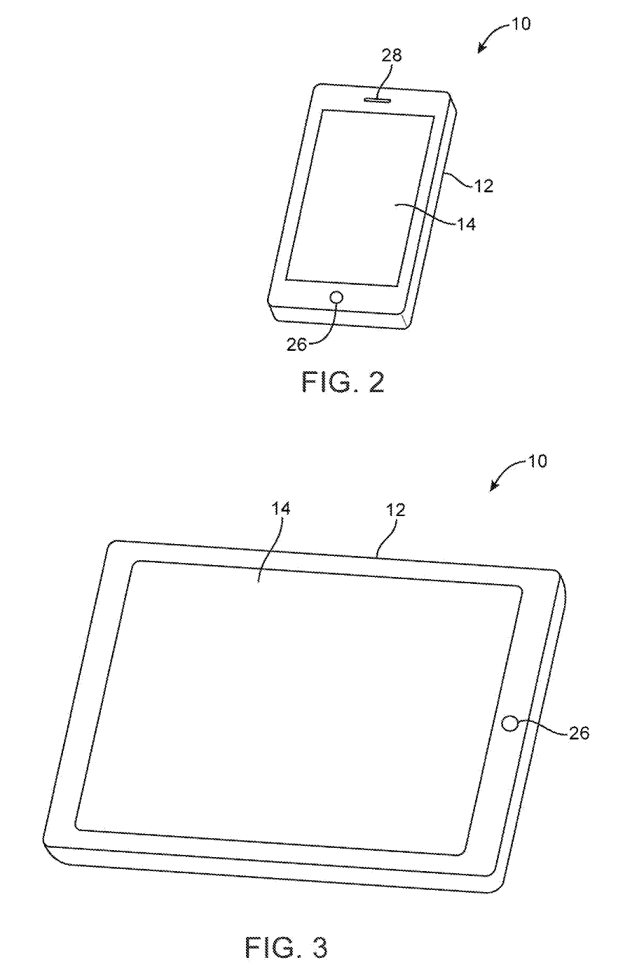

FIG. 2 shows how electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have a display cover layer or other exterior layer that includes openings for components such as button 26. Openings may also be formed in a display cover layer or other display layer to accommodate a speaker port (see, e.g., speaker port 28 of FIG. 2).

FIG. 3 shows how electronic device 10 may be a tablet computer. In electronic device 10 of FIG. 3, housing 12 may have opposing planar front and rear surfaces. Display 14 may be mounted on the front surface of housing 12. As shown in FIG. 3, display 14 may have a cover layer or other external layer with an opening to accommodate button 26 (as an example).

The illustrative configurations for device 10 that are shown in FIGS. 1, 2, and 3 are merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, may be formed of materials such as plastic, glass, ceramics, carbon-fiber composites and other fiber-based composites, metal (e.g., machined or cast aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Displays for device 10 may, in general, include image pixels formed from light-emitting diodes (LEDs), organic light-emitting diodes (OLEDs), plasma cells, electrowetting pixels, electrophoretic pixels, liquid crystal display (LCD) components, or other suitable image pixel structures. In some situations, it may be desirable to use LCD components to form display 14, so configurations for display 14 in which display 14 is a liquid crystal display are sometimes described herein as an example. It may also be desirable to provide displays such as display 14 with backlight structures, so configurations for display 14 that include a backlight unit may sometimes be described herein as an example. Other types of display technology may be used in device 10 if desired. The use of liquid crystal display structures and backlight structures in device 10 is merely illustrative.

A display cover layer may cover the surface of display 14 or a display layer such as a color filter layer or other portion of a display may be used as the outermost (or nearly outermost) layer in display 14. A display cover layer or other outer display layer may be formed from a transparent glass sheet, a clear plastic layer, or other transparent member.

Touch sensor components such as an array of capacitive touch sensor electrodes formed from transparent materials such as indium tin oxide may be formed on the underside of a display cover layer, may be formed on a separate display layer such as a glass or polymer touch sensor substrate, or may be integrated into other display layers (e.g., substrate layers such as a thin-film transistor layer).

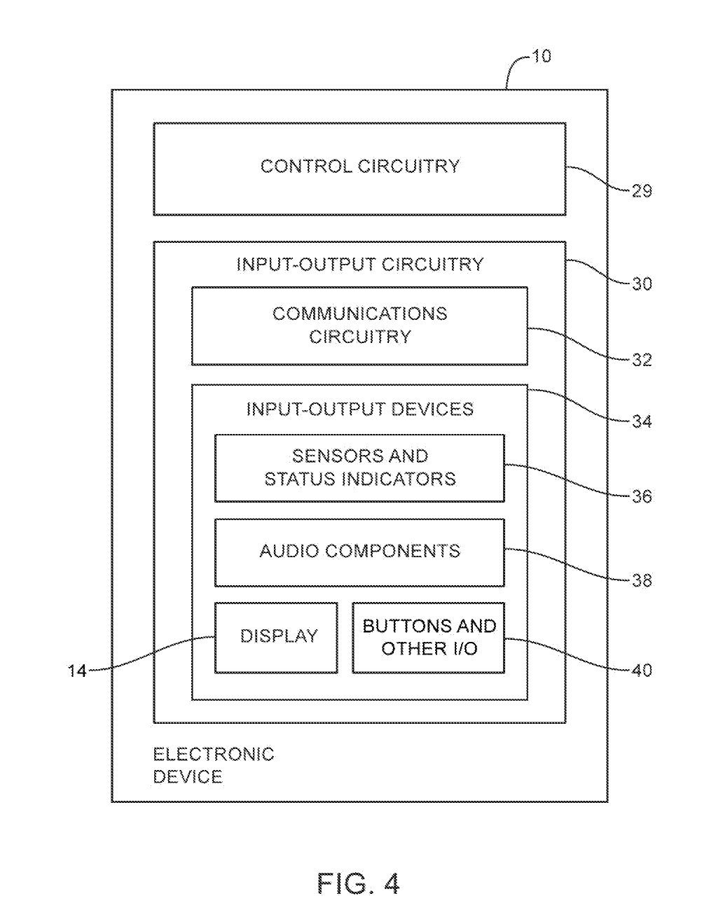

A schematic diagram of an illustrative configuration that may be used for electronic device 10 is shown in FIG. 4. As shown in FIG. 4, electronic device 10 may include control circuitry 29. Control circuitry 29 may include storage and processing circuitry for controlling the operation of device 10. Control circuitry 29 may, for example, include storage such as hard disk drive storage, nonvolatile memory (e.g., flash memory or other electrically-programmable-read-only memory configured to form a solid state drive), volatile memory (e.g., static or dynamic random-access-memory), etc. Control circuitry 29 may include processing circuitry based on one or more microprocessors, microcontrollers, digital signal processors, baseband processors, power management units, audio codec chips, application specific integrated circuits, etc.

Control circuitry 29 may be used to run software on device 10 such as operating system software and application software. Using this software, control circuitry 29 may present information to a user of electronic device 10 on display 14. When presenting information to a user on display 14, sensor signals and other information may be used by control circuitry 29 in making adjustments to the strength of backlight illumination that is used for display 14.

Input-output circuitry 30 may be used to allow data to be supplied to device 10 and to allow data to be provided from device 10 to external devices. Input-output circuitry 30 may include communications circuitry 32. Communications circuitry 32 may include wired communications circuitry for supporting communications using data ports in device 10. Communications circuitry 32 may also include wireless communications circuits (e.g., circuitry for transmitting and receiving wireless radio-frequency signals using antennas).

Input-output circuitry 30 may also include input-output devices 34. A user can control the operation of device 10 by supplying commands through input-output devices 34 and may receive status information and other output from device 10 using the output resources of input-output devices 34.

Input-output devices 34 may include sensors and status indicators 36 such as an ambient light sensor, a proximity sensor, a temperature sensor, a pressure sensor, a magnetic sensor, an accelerometer, and light-emitting diodes and other components for gathering information about the environment in which device 10 is operating and providing information to a user of device 10 about the status of device 10.

Audio components 38 may include speakers and tone generators for presenting sound to a user of device 10 and microphones for gathering user audio input.

Display 14 may be used to present images for a user such as text, video, and still images. Sensors 36 may include a touch sensor array that is formed as one of the layers in display 14.

User input may be gathered using buttons and other input-output components 40 such as touch pad sensors, buttons, joysticks, click wheels, scrolling wheels, touch sensors such as sensors 36 in display 14, key pads, keyboards, vibrators, cameras, and other input-output components.

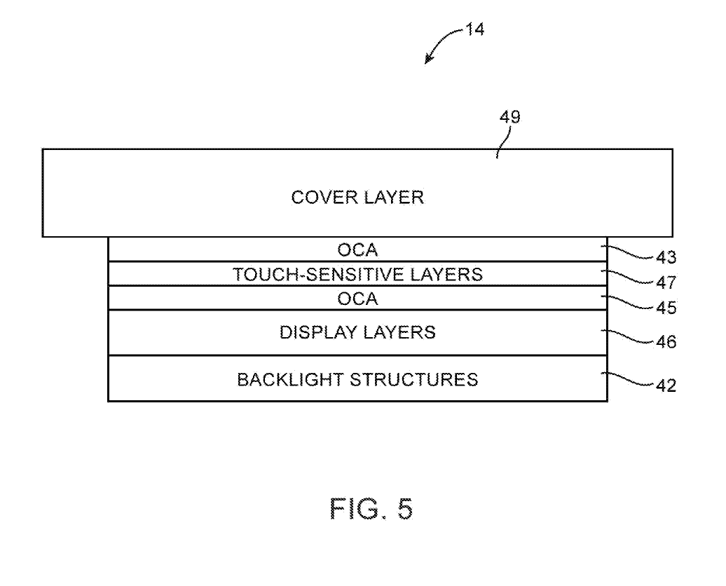

A cross-sectional side view of an illustrative configuration that may be used for display 14 of device 10 (e.g., for display 14 of the devices of FIG. 1, FIG. 2, or FIG. 3 or other suitable electronic devices) is shown in FIG. 5. As shown in FIG. 5, display 14 may include one or more layers of touch-sensitive components such as touch-sensitive layers 47 that are attached to a cover layer such as cover layer 49. Cover layer 49 may be formed from a sheet of rigid or flexible transparent material such as glass or plastic.

Touch-sensitive layers 47 may be attached to cover layer 49 using an adhesive material such as optically clear adhesive (OCA) 43. Adhesive 43 may be a liquid adhesive, light-cured adhesive, pressure-sensitive adhesive or other suitable adhesive. Touch-sensitive layers 47 may include touch sensor components such as an array of capacitive touch sensor electrodes formed from transparent materials such as indium tin oxide.

Display 14 may include display layers such as layers 46 for generating images to be displayed on display 14. Display layers 46 may include polarizer layers, color filter layers, transistor layers, adhesive layers, layers of liquid crystal material, or other layers for generating display images. Display layers 46 may be attached to touch-sensitive layers 43 using adhesive such as optically clear adhesive 45. Adhesive 45 may be a liquid adhesive, light-cured adhesive, pressure-sensitive adhesive or other suitable adhesive.

Display layers 46 may use light generated by light-generating structures such as backlight structures 42 to form images to be viewed by a user of device 10. Backlight structures 42 may include light-generating components such as light-emitting diodes, light guiding structures, reflective structures, optical films, etc. Backlight structures 42 may be attached to display layers 46 or may be mounted adjacent to layers 46 by attaching backlight structures 42 to one or more structural members.

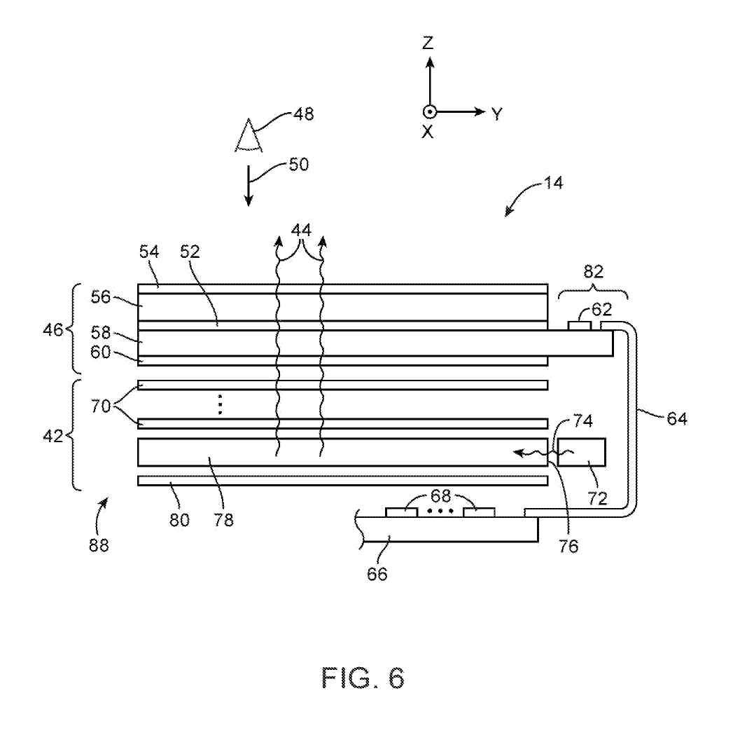

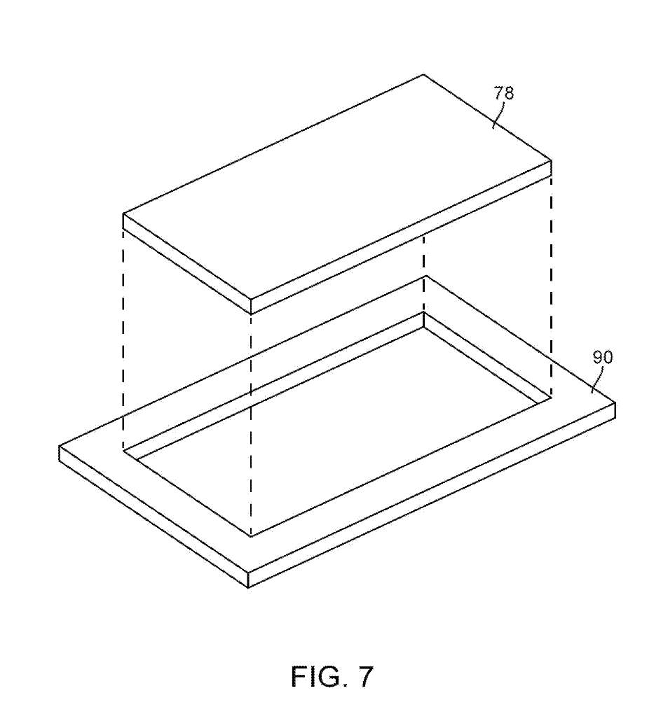

A cross-sectional side view of an illustrative configuration that may be used for display layers 46 and backlight structures 42 of display 14 (e.g., for display layers 46 and backlight structures 42 of the display of FIG. 5 or other suitable display) is shown in FIG. 6. As shown in FIG. 6, display 14 may include backlight structures such as backlight structures 42 for producing backlight 44. During operation, backlight 44 travels outwards (vertically upwards in dimension Z in the orientation of FIG. 6) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12). Display layers 46 may form a liquid crystal display or may be used in forming displays of other types.

In a configuration in which display layers 46 are used in forming a liquid crystal display, display layers 46 may include a liquid crystal layer such a liquid crystal layer 52. Liquid crystal layer 52 may be sandwiched between display layers such as display layers 58 and 56. Layers 56 and 58 may be interposed between lower polarizer layer 60 and upper polarizer layer 54. If desired, upper polarizer layer 54 may be attached to an outer cover layer such as cover layer 49 (FIG. 5).

Layers 58 and 56 may be formed from transparent substrate layers such as clear layers of glass or plastic. Layers 56 and 58 may include a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control circuitry 29 (e.g., one or more integrated circuits such as components 68 on printed circuit 66 of FIG. 6) may be used to generate information to be displayed on display 14 (e.g., display data). The information to be displayed may be conveyed from circuitry 68 to display driver integrated circuit 62 using a signal path such as a signal path formed from conductive metal traces in flexible printed circuit 64 (as an example).

Display driver integrated circuit 62 may be mounted on thin-film transistor layer driver ledge 82 or elsewhere in device 10. A flexible printed circuit cable such as flexible printed circuit 64 may be used in routing signals between printed circuit 66 and thin-film transistor layer 58. If desired, display driver integrated circuit 62 may be mounted on printed circuit 66 or flexible printed circuit 64.

Printed circuit 66 may be formed from a rigid printed circuit board (e.g., a layer of fiberglass-filled epoxy) or a flexible printed circuit (e.g., a flexible sheet of polyimide or other flexible polymer layer). However, these examples are merely illustrative. If desired printed circuits 64 and 66 may be formed from a combination of rigid and flexible printed circuit layers (e.g., printed circuit 66 may be formed from a rigid printed circuit board with a layer of flexible printed circuitry that extends from an edge of printed circuit 66 to form flexible printed circuitry 64 that attaches to thin-film transistor layer 58).

Backlight structures 42 may include a backlight light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed laterally in dimensions X and Y throughout light guide plate 78 due to the principal of total internal reflection. Light guide plate 78 may include light-scattering features such as pits or bumps or other light-scattering structures. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 6, optical films 70 and reflector 80 may have a matching rectangular footprint.

Display structures such as light guide plate 78 may be mounted in a support structure such as chassis structure 90 of FIG. 7. Chassis structure 90 may be formed from a ring of plastic or other suitable material that surrounds light guide plate 78 and that serves as an interface between the structures of display 14 and surrounding portions of housing 12 (e.g., a plastic ring with a thickness of about 0.2 to 1.5 mm, as an example). If desired, chassis structure 90 may be formed from a plate of material that includes a rectangular recess to accommodate display structures such as light guide plate 78. Chassis structure 90 may be formed from housing structures (e.g., as part of a housing frame, part of a unibody housing such as a metal housing, etc.). The arrangement of FIG. 7 in which chassis structure 90 surrounds light guide plate 78 is merely illustrative. If desired, chassis structure 90 may only partially surround light guide plate 78.

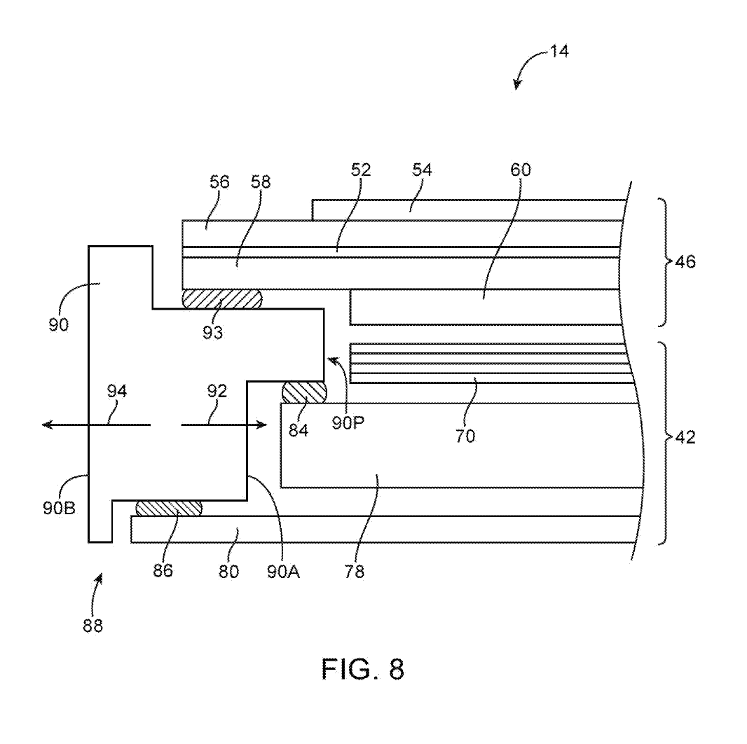

The arrangement of FIG. 6 in which display layers 46 are flush with backlight structures 42 along end 88 of display 14 is merely illustrative. If desired, display layers 46 and backlight structures 42 may have an arrangement such as the arrangement shown in FIG. 8. As shown in FIG. 8, the layers that make up display layers 46 and backlight structures 42 may extend to different lengths on side 88 of display 14.

Chassis structure 90 may be a plastic display chassis structure (sometimes referred to as a p-chassis). Chassis structure 90 may be used in supporting the layers and structures of display 14 such as display layers 46 and backlight structures 42. If desired, other support structures such as a metal chassis structure (sometimes referred to as an m-chassis) may be used in supporting display 14.

Chassis structure 90 may be formed from materials such as polycarbonate or may be formed from other suitable materials (e.g., other suitable thermoplastic polymers or plastics). Chassis structure 90 may be molded (e.g., using an injection molding process or other suitable molding process), machined, thermoformed, or may be formed using any other suitable fabrication process. This is, however, merely illustrative. If desired, chassis structure 90 may be formed from glass, ceramic, other materials, or a combination of these materials.

As shown in FIG. 8, chassis structure 90 may have a protruding portion such as protruding portion 90P that overlaps a portion of light guide plate 78. An adhesive such as adhesive 84 may be used to attach light guide plate 78 to protruding portion 90P of chassis structure 90. Reflector 80 may be attached to chassis structure 90 using an adhesive such as adhesive 86. A display layer such as display layer 58 may be attached to chassis structure 90 using adhesive 93. Adhesives 84, 86, and 93 may be liquid adhesives, light-cured adhesives, pressure-sensitive adhesives or other suitable adhesives.

In addition to providing support for display 14, chassis structure 90 may also be used to increase backlight efficiency and to reduce unwanted light leakage. For example, chassis structure 90 may be formed from light blocking materials and/or may be coated with light blocking materials that may be used to increase light reflections in direction 92 (e.g., to increase light reflections at inward facing surface 90A of chassis 90) and/or to decrease light transmission in direction 94 (e.g., to decrease light transmission at outward facing surface 90B of chassis 90). Light blocking materials may include materials that reflect, scatter, or absorb all or substantially all incident light (e.g., opaque materials or substantially opaque materials).

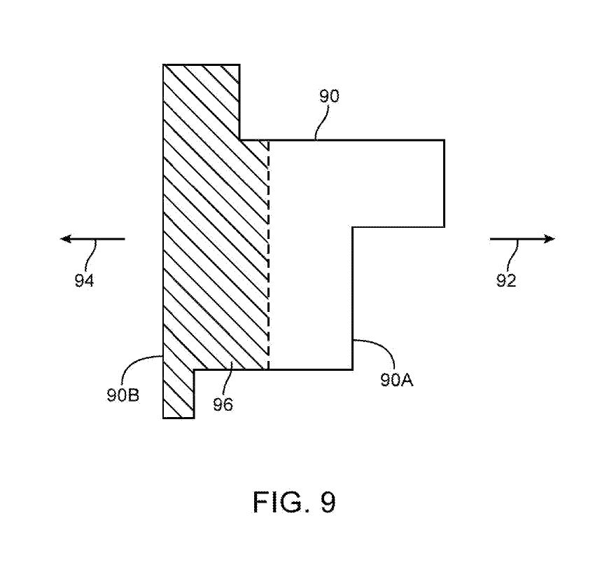

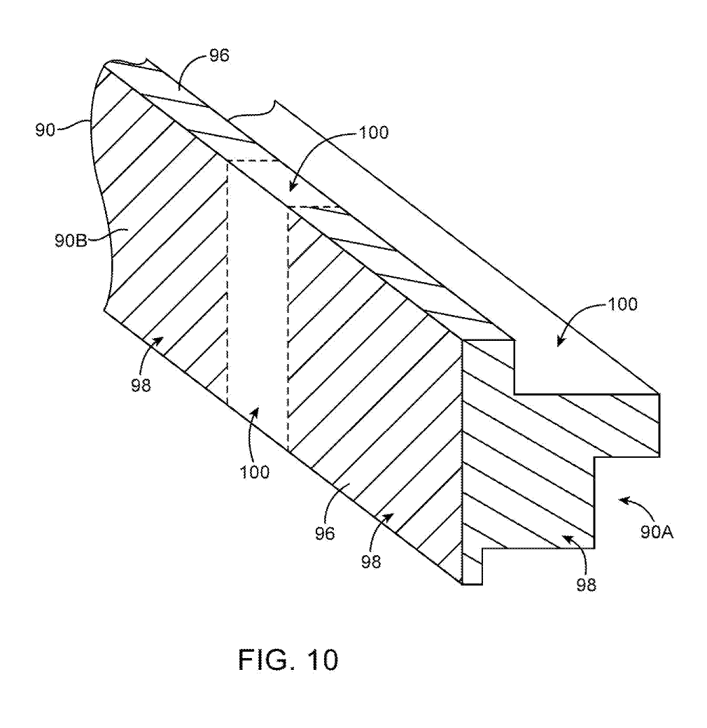

FIG. 9 is a cross-sectional side view of chassis structure 90 showing how chassis structure 90 may be formed from and coated with light blocking materials. In the example of FIG. 9, chassis structure 90 is formed from a light blocking material that exhibits relatively high reflectivity. Chassis structure 90 may, for example, be formed from materials such as white polycarbonate or other suitable light reflecting materials. Forming chassis structure 90 from a light reflecting material such as white polycarbonate may increase light reflections in direction 92 (e.g., may increase light reflections at interior surface 90A), thereby increasing the optical efficiency of backlight structures 42 (FIG. 8).

Chassis structure 90 may be coated with a light blocking material such light blocking material 96. Light blocking material 96 may be an opaque material such as opaque ink, opaque masking material, opaque film, opaque paint, opaque coating material, or other suitable light blocking substance. Light blocking material 96 may, for example, be a layer of black ink (e.g., a polymer filled with carbon black) formed on exterior surface 90B of chassis structure 90. Light blocking material 96 may be applied using spraying, dipping, physical vapor deposition, chemical vapor deposition, painting, or other suitable fabrication processes. Light blocking material 96 may be used to reduce or eliminate light transmission in direction 94 (e.g., may be used to reduce or eliminate light leakage from backlight structures 42 of FIG. 8).

If desired, light blocking material 96 may be selectively applied to the surface of chassis structure 90. FIG. 10 is a perspective view of chassis structure 90 showing how light blocking material 96 may be selectively applied to the surface of chassis structure 90. As shown in FIG. 10, portions such as portions 98 of chassis structure 90 may be covered with light blocking material 96, whereas portions such as portions 100 of chassis structure 90 may be free of light blocking material 96. This is, however, merely illustrative. In general, light blocking material 96 may be formed on any suitable portion of chassis structure 90. For example, light blocking material 96 may completely cover exterior surface 90B of chassis structure 90 (if desired). Selectively applying light blocking material 96 to the surface of chassis structure 90 may ensure that interior surface 90A of chassis 90 retains the reflective properties of the material from which chassis 90 is formed (e.g., white polycarbonate).

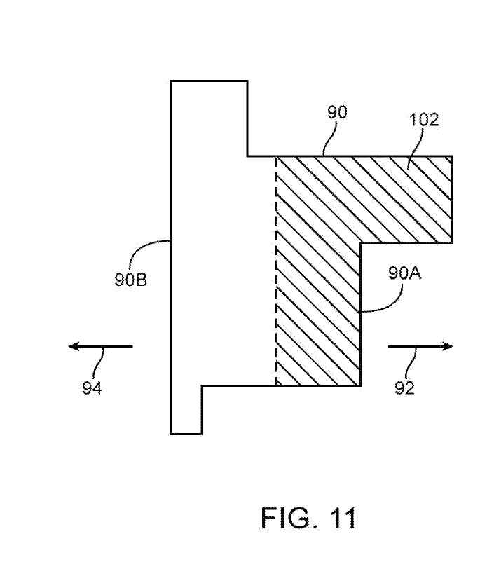

FIG. 11 is a cross-sectional side view of chassis structure 90 showing another illustrative configuration in which chassis structure 90 may be formed from and coated with light blocking materials. In the example of FIG. 11, chassis structure 90 is formed from a light blocking material such as an opaque plastic (e.g., black polycarbonate or other suitable opaque plastic). Forming chassis structure 90 from a light blocking material such as opaque plastic may reduce or eliminate light transmission in direction 94 (e.g., may reduce or eliminate light leakage from backlight structures 42 of FIG. 8).

Chassis structure 90 may be coated with a light blocking material such as light blocking material 102. Light blocking material 102 may be a material that exhibits relatively high reflectivity such as a light reflecting ink, masking material, film, paint, coating material, or other light reflecting substance. For example, light blocking material 102 may be a layer of white ink (e.g., a white colored polymer) or may be a layer of reflective film (e.g., a reflective film such as Vikuiti™ Enhanced Specular Reflector Film (ESR) or other suitable reflective film). Light blocking material 102 may be applied using spraying, dipping, physical vapor deposition, chemical vapor deposition, painting, or other suitable fabrication processes. Coating surface 90A of chassis structure 90 with light reflecting material 102 may increase light reflections in direction 92 (e.g., may increase light reflections at surface 90A), thereby increasing the optical efficiency of backlight structures 42 (FIG. 8).

If desired, light blocking material 102 may be selectively applied to the surface of chassis structure 90 or light blocking material 102 may completely cover interior surface 90A.

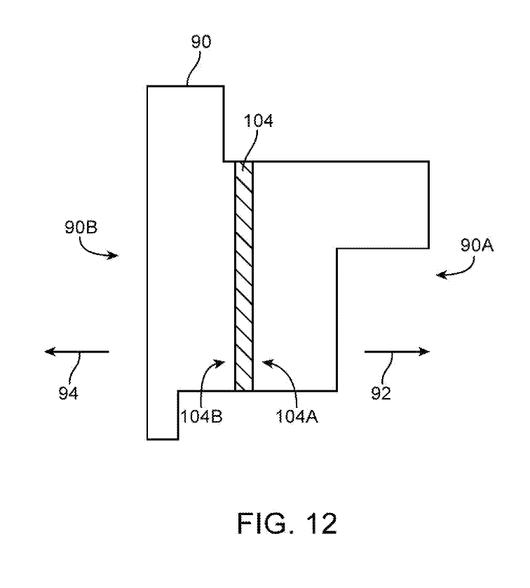

FIG. 12 is a cross-sectional side view of chassis structure 90 showing an illustrative configuration in which chassis structure 90 has been insert molded around a light barrier structure such as light barrier structure 104. Light barrier structure 104 may be a material that exhibits relatively high reflectivity at interior surface 104A (e.g., in direction 92) and that transmits little to no visible light at exterior surface 104B (e.g., in direction 94). Light barrier structure 104 may, for example, be formed from metal such as magnesium, aluminum, steel, other suitable metals, a combination of these metals, etc. As another example, light barrier 104 may be formed from plastic having a reflective coating on surface 104A and/or having an opaque coating on surface 104B, may be formed from black and white plastic (e.g., using a double shot injection molding process or other suitable fabrication process to produce a reflective surface at surface 104A and an opaque surface at surface 104B), or may be formed from other suitable materials.

Chassis 90 may be formed using an insert molding process. This may include injection molding molten plastic into a mold cavity that surrounds light barrier structure 104, thereby forming insert molded plastic chassis structure 90 around light barrier 104.

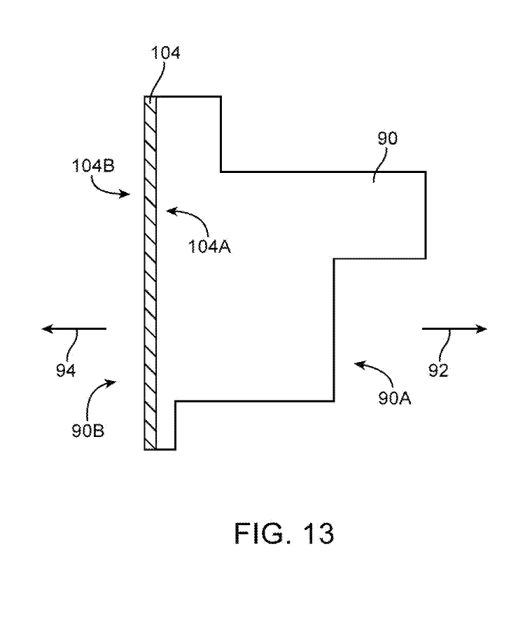

In the example of FIG. 12, light barrier 104 is formed in a central portion of chassis 90 (e.g., interposed between surfaces 90A and 90B of chassis 90). This is, however, merely illustrative. In general, light barrier 104 may be formed in any suitable location in or on chassis structure 90. FIG. 13 is a cross-sectional side view of chassis structure 90 in a configuration in which light barrier structure 104 is formed on surface 90B of chassis structure 90.

Light barrier structure 104 of FIG. 13 may be a metal or plastic insert around which chassis 90 is insert molded during an insert molding fabrication process (e.g., as described in connection with light barrier structure 104 of FIG. 12). As another example, light barrier structure 104 may be an opaque ink or coating which is formed on surface 90B of chassis 90 using an in-mold decorating process or other suitable fabrication process. Light barrier 104 may be formed from or coated with reflective material and/or opaque material such that reflections are enhanced at surface 104A and such that light transmission is minimized at surface 104B.

If desired, light barrier structure 104 may be formed from metal which is plated on surface 90B of chassis 90. Surface 90B of chassis 90 may be metal plated with light barrier structure 104 using any suitable process (e.g., using electroplating, laser direct structuring (LDS), physical vapor deposition (PVD), vacuum metalizing, other suitable fabrication processes, etc.). In addition to reducing light leakage and increasing backlight efficiency, forming light barrier structure 104 from metal may also provide electromagnetic shielding to reduce unwanted electromagnetic interference between display circuitry and other circuitry in device 10 such as radio-frequency transceiver circuitry. Forming light barrier 104 from metal may also allow light barrier 104 to serve as a grounding structure for grounding conductive display structures to conductive structures in device 10 such as a conductive electronic device housing member or a metal display chassis structure.

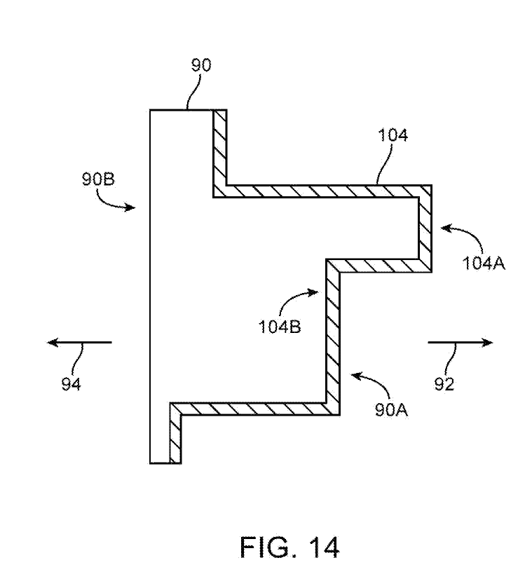

FIG. 14 is a cross-sectional side view of chassis structure 90 in a configuration in which light barrier structure 104 has been formed on interior surface 90A of chassis 90. Light barrier structure 104 may be a metal or plastic insert around which chassis 90 is molded during an insert molding fabrication process. As another example, light barrier 104 may be an opaque ink or coating which is formed on surface 90A of chassis 90 using an in-mold decorating process or other suitable fabrication process. Light barrier structure 104 may be formed from or coated with reflective material and/or opaque material such that reflections are enhanced at surface 104A and such that light transmission is minimized at surface 104B.

If desired, light barrier 104 may be formed from a reflective film such as Vikuiti™ Enhanced Specular Reflector Film (ESR) or other suitable reflective film. Using an opaque film with relatively high reflectivity may provide some flexibility in the types of materials that are used to form chassis structure 90. For example, if light barrier 104 exhibits high reflectivity at surface 104A and little to no visible light transmission at surface 104B, then chassis structure 90 need not be formed from opaque or reflective materials. Materials from which chassis structure 90 is formed may be chosen based on factors such as bond compatibility, stiffness, weight, and/or other properties (if desired).

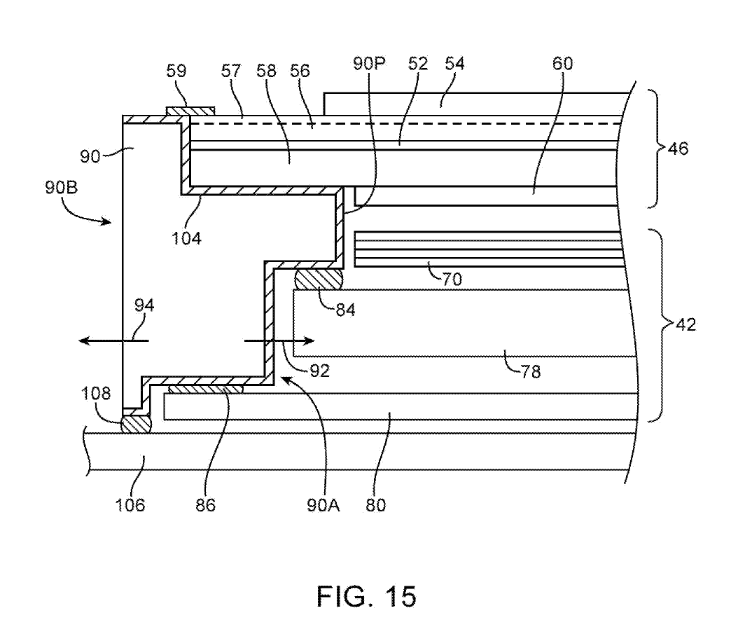

As another example, light barrier structure 104 may be formed from metal. Forming light barrier 104 from metal may provide a ground path from conductive display structures to other conductive structures in device 10. An illustrative configuration in which light barrier structure 104 is used to ground display structures in display 14 is shown in FIG. 15. As shown in FIG. 15, interior surface 90A of chassis structure 90 may be covered or partially covered with light barrier structure 104. Light barrier structure 104 may be formed from metal such as magnesium, aluminum, steel, other suitable metals, a combination of these metals, etc.

Displays such as display 14 may include conductive structures. For example, one or more transparent electric field shielding layers may be incorporated into the display above the liquid crystal layer. Incorporating one or more electric field shielding layers into the display may ensure that electric fields caused by electrostatic charges do not disturb liquid crystal layer 52. As shown in FIG. 15, display layer 56 (e.g., a color filter layer or other suitable display layer) may include an electric field shielding layer such as electrostatic discharge (ESD) protection layer 57. Protruding portion 90P of chassis structure 90 may be interposed between ESD protection layer 57 and light guide plate 78.

ESD protection layer 57 may be formed from conductive adhesive, metal oxides, conductive polymers, materials that include nanostructures such as carbon nanotubes, materials that include metal particles, conductive inks, or other conductive materials. ESD protection layer 57 may, for example, be a blanket layer of indium tin oxide (ITO) formed on the surface of display layer 56.

Conductive layer 57 may be shorted to metal barrier structure 104. For example, a conductive material such as conductive material 59 may electrically couple conductive layer 57 to metal barrier structure 104. Conductive material 59 may be formed from conductive adhesive (e.g., anisotropic conductive film), conductive tape (e.g., conductive fibers embedded in adhesive), solder, or other conductive substances. This is, however, merely illustrative. If desired, metal barrier structure 104 may be directly electrically connected to layer 57, and conductive material 59 may be omitted.

Metal barrier structure 104 may ground conductive layer 57 to a conductive structure in device 10 such as conductive structure 106. Conductive support structure 106 may be a metal display chassis structure or may (if desired) be a metal electronic device housing member. A conductive material such as conductive material 108 may be used to short metal barrier structure 104 to conductive support structure 106. Conductive material 108 may be solder, metal associated with a weld, part of a connector, conductive adhesive (e.g., anisotropic conductive film), or other suitable material for forming an electrical connection between light barrier structure 104 and metal structure 106.

The examples in which light barrier structure 104 is used to ground ESD protection layer 57 to a metal display chassis structure or a conductive housing member are merely illustrative. If desired, light barrier structure 104 may be used to ground ESD protection layer 57 to a printed circuit board in device 10 or to other suitable conductive structures in device 10.

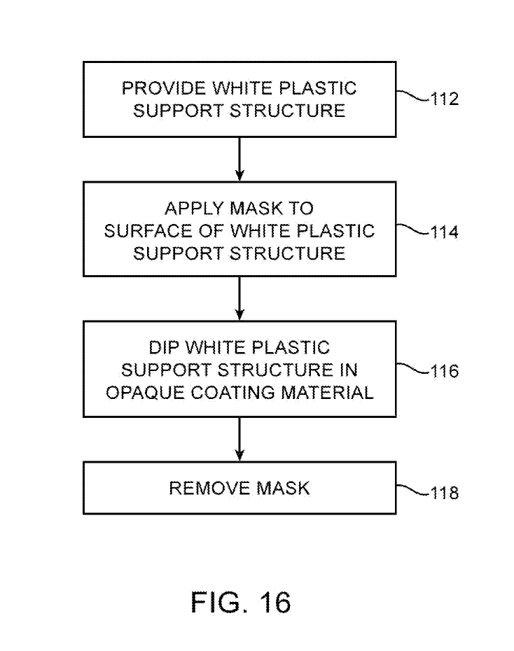

A flow chart of illustrative steps involved in forming a chassis structure of the type shown in FIG. 9 is shown in FIG. 16.

At step 112, a plastic support structure such as display chassis structure 90 may be provided. Display chassis structure 90 may be formed using any suitable fabrication process (e.g., molding, machining, thermoforming, etc.). Chassis structure 90 may be formed from a material that exhibits high reflectivity such as white polycarbonate or other suitable material.

At step 114, a mask may be applied to the surface of chassis structure 90. The mask may be used to block areas of chassis structure 90 on which no coating is to be formed (e.g., areas of chassis structure 90 in which the white polycarbonate is to remain exposed). For example, a mask may be applied to portions 100 of chassis 90 (FIG. 10) during step 114 so that interior surface 90A of chassis 90 remains reflective.

At step 116, chassis structure 90 may be dipped in an opaque coating material such as light blocking material 96 (FIG. 9). Light blocking material 96 may be black ink (e.g., a polymer filled with carbon black) or other suitable opaque coating material. Portions of chassis 90 which have not been covered with a mask may therefore be coated with light blocking material 96 in which chassis 90 is dipped. For example, portions such as portions 98 of chassis 90 (FIG. 10) may be covered with light blocking material 96 during step 116 so that exterior surface 90B of chassis 90 transmits little to no visible light.

At step 118, the mask which was applied during step 114 may be removed to expose reflective portions 100 of chassis structure 90. Reflective portions 100 on interior surface 90A of chassis 90 may increase backlight efficiency by reflecting light from backlight components 42 in direction 92, whereas opaque portions 98 (e.g., portions coated with light blocking material 96) on exterior surface 90B may reduce or eliminate unwanted light leakage from backlight components 42 to the exterior of device 10.

If desired, other fabrication techniques may be used to form chassis structure 90 of FIG. 9. The example in which white polycarbonate is masked and then dipped in an opaque coating such as black ink is merely illustrative.

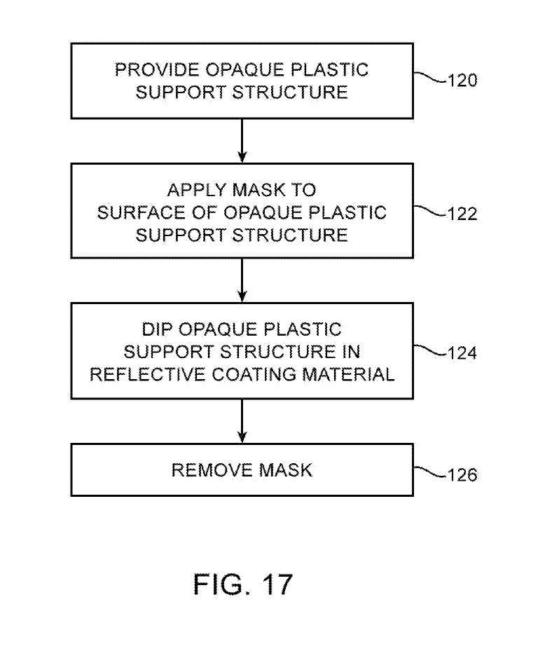

FIG. 17 is a flow chart of illustrative steps involved in forming a chassis structure of the type shown in FIG. 11.

At step 120, a plastic support structure such as display chassis structure 90 may be provided. Display chassis structure 90 may be formed using any suitable fabrication process (e.g., molding, machining, thermoforming, etc.). Chassis structure 90 may be formed from a material that transmits little to no visible light such as an opaque plastic (e.g., black polycarbonate) or other suitable opaque material.

At step 122, a mask may be applied to the surface of chassis structure 90. The mask may be used to block areas of chassis structure 90 on which no coating is to be formed (e.g., areas of chassis structure 90 in which the black polycarbonate is to remain exposed). This may include applying a mask to exterior surface 90B of chassis 90 so that exterior surface 90B remains black.

At step 124, chassis structure 90 may be dipped in a reflective coating material such as light reflecting material 102 (FIG. 11). Light reflecting material 102 may be white ink (e.g., a white colored polymer) or other suitable reflective coating material. Portions of chassis 90 which have not been covered with a mask may therefore be coated with light reflecting material 102 in which chassis 90 is dipped. For example, interior surface 90A of chassis 90 may be covered with light reflecting material 102 during step 124 so that interior surface 90A exhibits high reflectivity.

At step 124, the mask which was applied during step 122 may be removed to expose black portions of chassis structure 90 (e.g., on exterior surface 90B of chassis 90). The black portions of chassis 90 may reduce or eliminate unwanted light leakage from backlight components 42 to the exterior of device 10, whereas reflective portions (e.g., portions coated with light reflecting material 102) on interior surface 90A of may enhance backlight efficiency by reflecting light from backlight components 42 in direction 92.

If desired, reflective coating 102 may be applied to all or substantially all of chassis structure 90. With this type of configuration, steps 122 and 126 may be omitted (e.g., a mask need not be applied to the surface of chassis structure 90).

Other fabrication techniques may be used to form chassis structure 90 of FIG. 11 (if desired). The example in which black polycarbonate is masked and then dipped in a reflective coating such as white ink is merely illustrative.

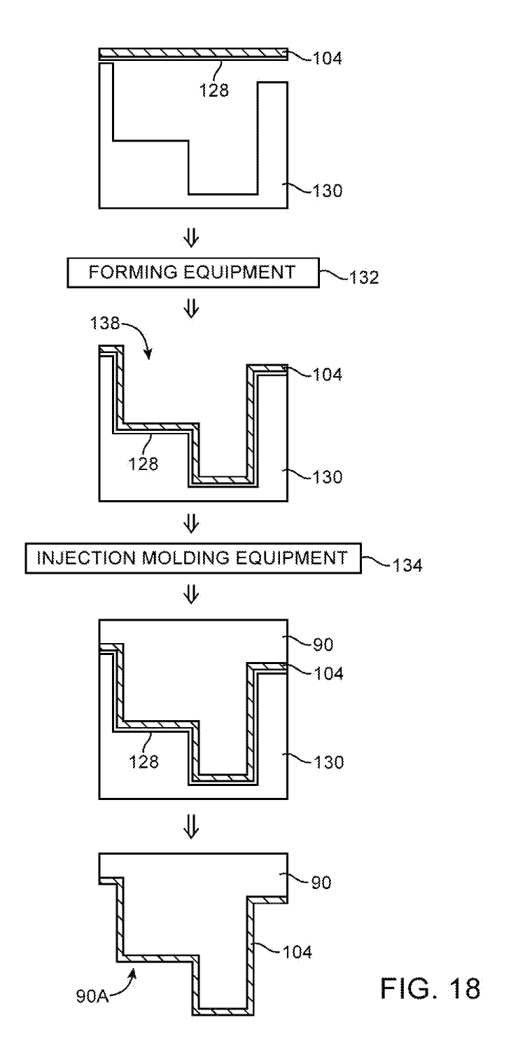

FIG. 18 is a diagram showing how in-mold decorating techniques may be used to form a light barrier such as light barrier 104 of FIG. 14 on the surface of a chassis structure such as chassis structure 90.

Light barrier 104 may be formed in any desired pattern on the surface of chassis structure 90. The desired pattern in which light barrier 104 is to be formed on chassis 90 may first be printed on a carrier film such as carrier film 128. This may include using screen printing techniques to print a reflective ink such as white ink onto carrier film 128 in the desired pattern.

Forming equipment such as forming equipment 132 may be used to form carrier film 128 to the surface of a mold such as mold 130. Forming equipment 132 may form carrier film 128 to the surface of mold 130 using any suitable forming technique (e.g., vacuum forming, pressure forming, hydroforming, matched metal forming, etc.).

After forming carrier film 128 and ink 104 to the surface of mold 130, injection molding equipment such as injection molding equipment 134 may be used in injecting molten plastic (e.g., opaque molten plastic) into cavity 138, thereby forming plastic support structure 90. If desired, injection molding equipment 134 may include mold structures that are used in conjunction with mold structure 130 to form a cavity into which molten plastic is injected.

Following formation of chassis 90 in mold cavity 138, mold 130 may be opened and removed. Plastic structure 90 may form a chemical bond with film 128, thereby adhering ink 104 to the surface of plastic structure 90.

In the example of FIG. 17, in-mold decorating techniques are used to form light barrier structure 104 on interior surface 90A of chassis structure 90 (e.g., to form a chassis structure of the type shown in FIG. 14). This is, however, merely illustrative. If desired, the processing steps of in-mold decorating described in connection with FIG. 17 may be performed in a similar manner to fabricate chassis structure 90 of FIG. 13 in which light barrier 104 is formed on exterior surface 90B of chassis structure 90.

The foregoing is merely illustrative of the principles of this invention and various modifications can be made by those skilled in the art without departing from the scope and spirit of the invention.

What is claimed is:

1. An electronic device, comprising:
a display having an electrostatic discharge protection layer;
a light source configured to provide light;
a light guide plate configured to receive the light and to provide the light to the display as backlight illumination;
a plastic chassis that surrounds the light guide plate;
a conductive support structure; and
a metal barrier structure formed on a surface of the plastic chassis that electrically connects the electrostatic discharge protection layer to the conductive support structure.

2. The electronic device defined in claim 1 wherein the electrostatic discharge layer comprises a layer of indium tin oxide.

3. The electronic device defined in claim 1 wherein the plastic chassis comprises an insert molded plastic chassis and wherein the insert molded plastic chassis is insert molded around the metal barrier structure.

4. The electronic device defined in claim 1 wherein the plastic chassis comprises a protruding portion to which the light guide plate is adhered.

5. The electronic device defined in claim 1 wherein the conductive support structure comprises a metal display chassis.

6. The electronic device defined in claim 1 wherein the conductive support structure comprises a metal electronic device housing member.

7. The electronic device defined in claim 1 wherein the metal barrier structure comprises an electroplated metal barrier structure interposed between the surface of the plastic chassis and the light guide plate.

8. The electronic device defined in claim 1 wherein the metal barrier structure comprises magnesium.

9. An electronic device, comprising:
a display;
a light source configured to provide light;
a light guide plate configured to receive the light and to provide the light to the display as backlight illumination;
a plastic chassis adjacent to the light guide plate and configured to support the display; and
a light barrier structure formed within the plastic chassis, wherein the light barrier structure is configured to reflect the light through the plastic chassis towards the light guide plate.

10. The electronic device defined in claim 9 wherein the light barrier structure comprises metal.

11. The electronic device defined in claim 9 wherein the light barrier structure comprises opaque plastic.

12. The electronic device defined in claim 9 wherein the plastic chassis comprises an insert molded plastic display chassis that is insert molded around the light barrier structure.

13. The electronic device defined in claim 9 wherein the plastic chassis comprises white polycarbonate.

14. The electronic device defined in claim 15 further comprising a reflective film interposed between the plastic chassis and the light guide plate, wherein the reflective film is configured to reflect the light towards the light guide plate.

15. Apparatus, comprising:
a display having an electric field shielding layer;
a light source configured to provide light;
a light guide plate configured to receive the light and to provide the light to the display as backlight illumination;
a chassis structure that surrounds the light guide plate; and
conductive material formed on a surface of the chassis structure and electrically connected to the electric field shielding layer.

16. The apparatus defined in claim 15 further comprising a metal display chassis, wherein the conductive material electrically connects the electric field shielding layer to the metal display chassis.

17. The apparatus defined in claim 15 wherein the display comprises a color filter layer and wherein the electric field shielding layer comprises a blanket layer of indium tin oxide formed on a surface of the color filter layer.

18. The apparatus defined in claim 15 wherein the conductive material comprises electroplated metal configured to reflect the light towards the light guide plate.

19. The apparatus defined in claim 15 wherein the conductive material comprises a layer of metal, wherein the chassis structure comprises an insert molded plastic display chassis, and wherein the insert molded plastic display chassis is insert molded around the layer of metal.

20. The apparatus defined in claim 15 further comprising an adhesive, wherein the chassis structure has a protruding portion interposed between the electric field shielding layer and the light guide plate and wherein the adhesive attaches the light guide plate to the protruding portion of the chassis structure.
